(19) United States
(12) Patent Application Publication
(10) Pub. No.: US 2016/0340935 A1
(43) Pub. Date: Nov. 24, 2016

(54) SYSTEM FOR UNLOCKING PORTABLE ELECTRONIC DEVICE AND METHOD THEREOF

(71) Applicant: HON HAI PRECISION INDUSTRY CO., LTD., New Taipei (TW)

(72) Inventor: MENG-HSIEN CHUANG, New Taipei (TW)

(21) Appl. No.: 14/837,538

(22) Filed: Aug. 27, 2015

(30) Foreign Application Priority Data
May 21, 2015 (TW) 104116353

(51) Int. Cl. E05B 73/00

(52) U.S. Cl. CPC E05B 73/0082; E05B 2073/0088

(57) ABSTRACT

A portable electronic device can be switched between locked and unlocked states by handheld motion. The portable electronic device includes a display screen, a storage device stored unlocking information, a control unit, an inputting unit, and a comparison unit. An unlocking interface is displayed on a display screen when the portable electronic device is locked. The unlocking interface includes a compass with a plurality of prompting characters and a pointer. The inputting unit orderly inputs characters while the portable electronic device is rotated to change and acquire a prompting character which is facing the pointer. The comparison unit compares the total of input characters and the unlocking information, and unlocks the portable electronic device when the input information is identical to the unlocking information. Either the compass or the pointer can rotate to change the prompting character which is facing the pointer.

### CROSS-REFERENCE TO RELATED APPLICATIONS

This application claims priority to Taiwanese Patent Application No. 104116353 filed on May 21, 2015, the contents of which are incorporated by reference herein.

### FIELD

The subject matter herein generally relates to electronic device security.

### BACKGROUND

A portable electronic device can switch between a locked state and a unlocked state. A common unlocking technique for the portable electronic device in the locked state is to input an alpha-numeric password using a physical keypad of the electronic device or a virtual keypad displayed on a touch screen of the portable electronic device.

### BRIEF DESCRIPTION OF THE FIGURES

Many aspects of the embodiments can be better understood with reference to the following drawings. The components in the drawings are not necessarily drawn to scale, the emphasis instead being placed upon clearly illustrating the principles of this disclosure. Moreover, in the drawings, like reference numerals designate corresponding parts throughout the views.

FIG. 1 is a block diagram of an embodiment of a portable electronic device.

FIG. 2 is a diagrammatic view of an embodiment of the portable electronic device of FIG. 1 displaying an unlocking interface with a first input prompting character.

FIG. 3 is a diagrammatic view of an embodiment of the portable electronic device of FIG. 2 displaying the unlocking interface with two input prompting characters.

FIG. 4 is a diagrammatic view of an embodiment of the portable electronic device of FIG. 3 displaying the unlocking interface with three input prompting characters.

FIG. 5 is a flowchart of an embodiment of the unlocking method for unlocking a portable electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising” means “including, but not necessarily limited to”; it specifically indicates open-ended inclusion or membership in a so-described combination, group, series and the like.

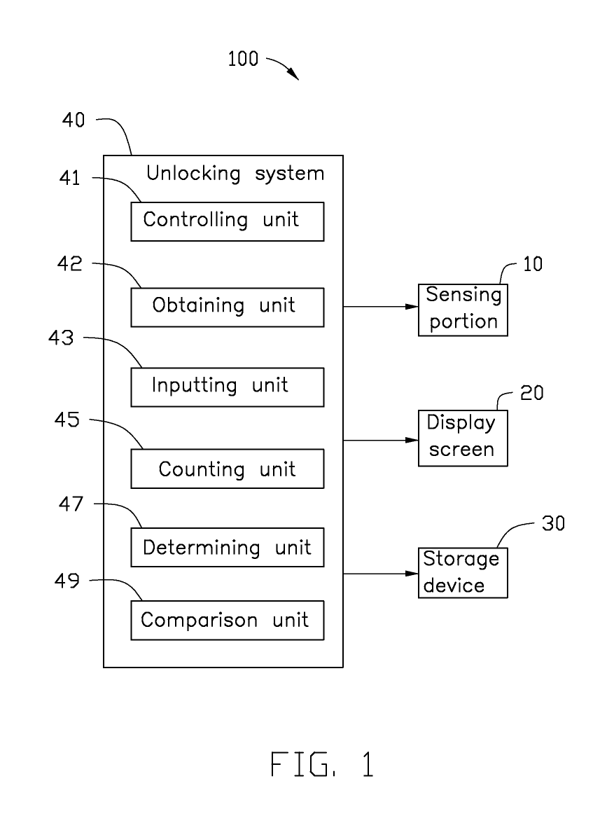

FIG. 1 illustrates an embodiment of a portable electronic device 100. The portable electronic device 100 displays images, and is capable of switching between a locked state and a unlocked state. In at least one embodiment, the portable electronic device 100 is a mobile device. In other embodiments, the portable electronic device 100 can be a tablet or a personal digital assistant (PDA).

The portable electronic device 100 includes a sensing portion 10, a display screen 20, a storage device 30, and an unlocking system 40, which can communicate with each other by wires or wirelessly.

The sensing portion 10 senses a rotating direction of the portable electronic device 100, and communicates with the unlocking system 40. In at least embodiment, the sensing portion 10 can be an acceleration transducer, an electronic compass, or a combination of the acceleration transducer and the electronic compass.

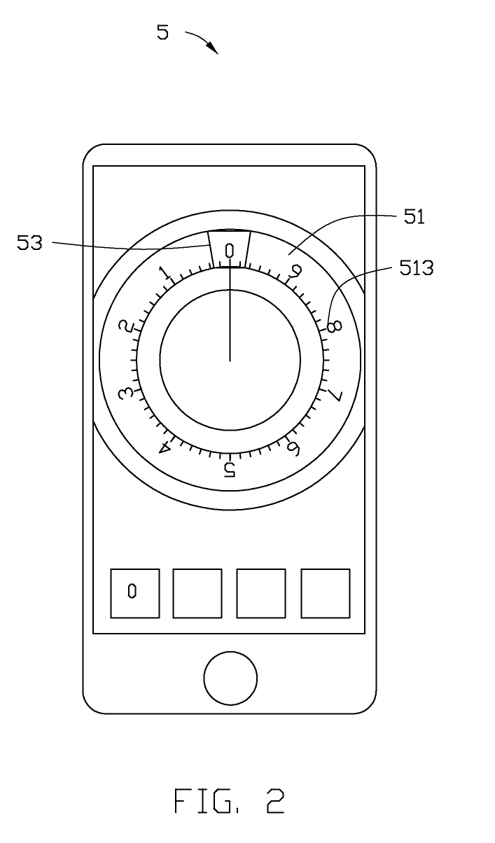

FIG. 2 illustrates an example of an interface of the display screen 20 in the locked state. The display screen 20 displays an unlocking interface 5 when the portable electronic device 100 is in the locked state, and displays a normal user interface when the portable electronic device 100 is in the unlocked state. The unlocking interface 5 includes a compass 51 and a pointer 53. Either the compass 51 or the pointer 53 can rotates with the portable electronic device 100. The compass 51 includes a plurality of prompting characters 513 arranged in a circle. The prompting characters 513 are equidistantly spaced from each other. The pointer 53 is capable of facing one of the prompting characters 513. In at least one embodiment, the compass 51 rotates with the portable electronic device 100 to change the prompting character 513 which is facing the pointer 53. The pointer 53 remains pointing to a predetermined direction while the portable electronic device 100 rotates. The pointer 53 remains pointing to a top side of the portable electronic device. A prompting character 513 can be a letter, a number, or a combination of a letter and a number. In other embodiments, the pointer 53 rotates with the portable electronic device 100 to point to a different prompting character 513. The compass 51 remains static while the portable electronic device 100 rotates.

The storage device 30 stores unlocking information. The unlocking information comprises a predetermined number of specified characters and rotating directions. The storage device 30 can be an internal storage device, such as a random access memory (RAM) for temporary storage of information, and/or a read only memory (ROM) for permanent storage of information. The storage device 30 can also be an external storage device, such as an external hard disk, a storage card, or a data storage medium.

The unlocking system 40 identifies as input information a rotating direction of the portable electronic device 100 and the prompting character 513 facing the pointer 53 when the portable electronic device 100 stops rotating, and compares an input information with the unlocking information. When the total input information is identical to the unlocking information, the unlocking system 40 switches the portable electronic device 100 into the unlocked state. In at least one embodiment, the unlocking operation can unlock a display screen of the portable electronic device 100, a keyboard of the portable electronic device 100, or an encryption program of the portable electronic device 100.

The unlocking system 40 includes a controlling unit 41, an obtaining unit 42, an inputting unit 43, a counting unit 45, a determining unit 47, and a comparison unit 49.

The controlling unit 41 controls the display screen 20 to display the unlocking interface 5. In at least one embodiment, the controlling unit 41 controls the display screen 20 to display the unlocking interface 5 when a specified mechanical key or a specified virtual key of the portable electronic device is pressed.

The obtaining unit 42 obtains the rotating direction of the portable electronic device 100 sensed by the sensing portion 10.

The inputting unit 43 obtains as an input character the one of the prompting characters 513 which is facing the pointer 53 when the portable electronic device 100 stops rotating, and orderly displays the input characters on the unlocking interface 5. The inputting unit 43 further stores the input characters and the corresponding rotating direction as input information in the storage device 30. In at least one embodiment, the inputting unit 43 counts the period of time of the portable electronic device 100 being static and obtains the prompting character 513 facing the pointer 53 when the counted time equals a predetermined time. The predetermined time is 2 seconds. The predetermined time can be set by operation of user. In other embodiments, the inputting unit 43 obtains the prompting character 513 facing the pointer 53 as the input character, and orderly displays a specified symbol on the unlocking interface 5 when the portable electronic device 100 stop rotating. The specified symbol can be a block point or a “*” symbol representing a prompting character 513.

The counting unit 45 acquires a certain number of the input character and stores the acquired number in the storage device 30.

The determining unit 47 determines whether the number of the input characters is equal to a predetermined value. When the number of input characters is equal to a predetermined value, the determining unit 47 controls the comparison unit 49 to execute a comparison operation.

The comparison unit 49 compares the total input information with the unlocking information. When the total input information is identical to the unlocking information, the comparison unit 49 controls the portable electronic device 100 to be unlocked.

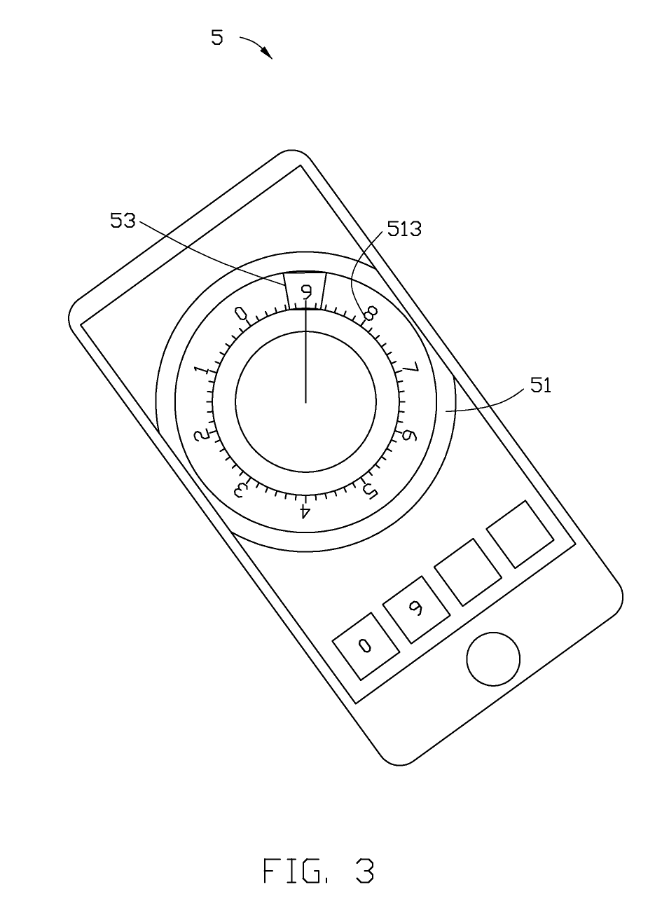

FIG. 3 illustrates the unlocking interface 5 displayed in the display screen 20 during an unlocking operation. The prompting characters 513 are numbers arranged in a circle, for example, the numbers 0-9. The pointer 53 points at “0”. When the counted time of the portable electronic device 100 reaches the predetermined time, the unlocking interface 5 display “0”. Then, the portable electronic device 100 rotates anti-clockwise. FIG. 3 illustrates that the pointer 53 points at “9” after the counted time. The unlocking interface 5 orderly displays “0” and “9”. Then, the portable electronic device 100 rotates along a clockwise direction. FIG. 3 illustrates that the pointer 53 points at “1” after the counted time. The unlocking interface 5 orderly displays “0”, “9”, and “1”.

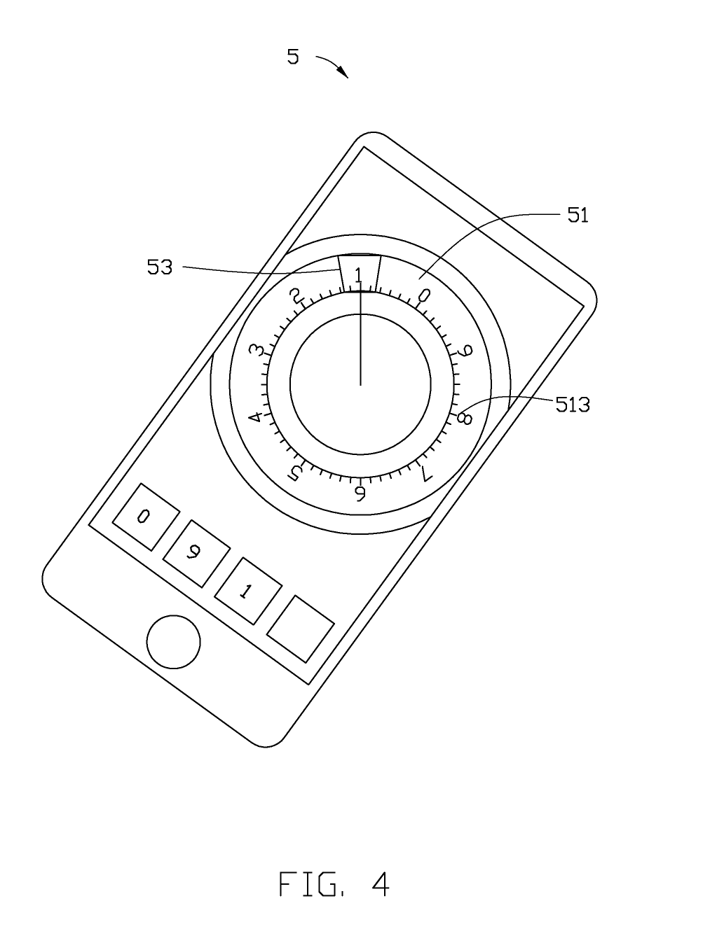

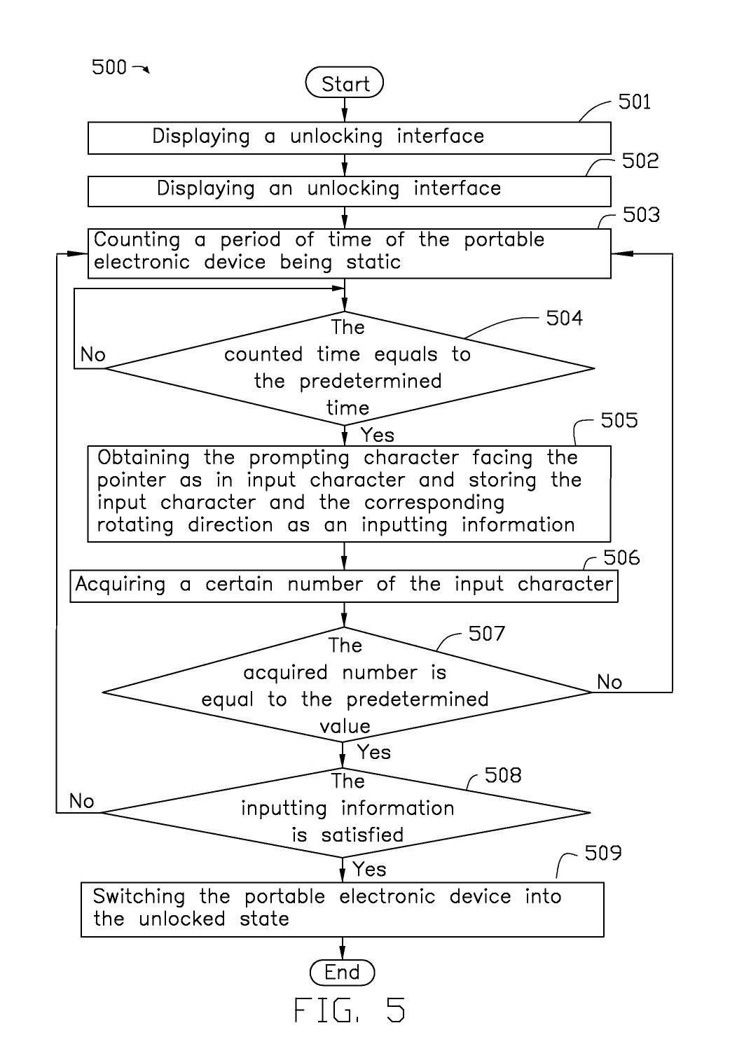

FIG. 5 illustrates a flowchart of an embodiment of a unlocking method for the portable electronic device 100. The method 500 is provided by way of example, as there are a variety of ways to carry out the method. The method 500 described below can be carried out using the configurations illustrated in FIGS. 1-4, for example, and various elements of these figures are referenced in explaining the method 500. Each block shown in FIG. 5 represents one or more processes, methods, or subroutines, carried out in the method 500. Furthermore, the order of blocks is illustrative only and the order of the blocks can change. Additional blocks can be added or blocks can be removed, without departing from this disclosure. The method 500 can begin at block 51.

At block 501, the controlling unit 41 controls the display screen 20 to display an unlocking interface 500 with a compass 51 and a pointer 53. The compass 51 includes a plurality of prompting characters 513 arranged in a circle. The compass 51 or the pointer 53 can be capable of rotating with the portable electronic device 100. In at least one embodiment, the compass 51 rotates with the portable electronic device 100 to change the prompting character 513 which face the pointer 53. The pointer 53 remains pointing to a predetermined direction while the portable electronic device 100 rotates. The pointer 53 remains pointing to a top side of the portable electronic device. The prompting characters 513 can be a letter, a number, or a combination of a letter and a number. In other embodiments, the pointer 53 rotates with the portable electronic device 100 to point to a different prompting character 513. The compass 51 remains static while the portable electronic device 100 rotates.

At block 502, the obtaining unit 42 obtains the rotating direction by the sensing portion 10 when the portable electronic device 100 rotates.

At block 503, the inputting unit 43 counts a period of time after the portable electronic device 100 has stopped rotating.

At block 504, the inputting unit 43 determines whether the counted period of time reaches a predetermined time. When the counted period of time reaches the predetermined time, the procedure goes to block 505. Until the counted period reaches the predetermined time, the procedure remains in block 503.

At block 505, the inputting unit 43 obtains the prompting character 513 facing the pointer 53 as an input character, and stores the input character 513 and the rotating direction as input information, in the storage device 30. In at least one embodiment, the inputting unit 43 further controls the display screen 20 to orderly display the input character on the unlocking interface 500, as shown in FIGS. 2-4. In other embodiments, the inputting unit 43 further controls the display screen to orderly display a specified symbol on the unlocking interface 500 in place of a prompting character. The specified symbol can be a block point or a “*” symbol.

At block 506, the counting unit 45 acquires a number of the input characters.

At block 507, the determining unit 47 determines whether the acquired number of input characters is equal to a predetermined value. When the acquired number of input characters is equal to the predetermined value, the procedure goes to block 508.

At block 508, the comparison unit 49 determines whether the input information is satisfying. When the input information is identical to unlocking information, the comparison unit 49 determines that the input information is satisfactory, and the procedure goes to block 59. When the input information is not identical to unlocking information, the comparison unit 49 determines that the input information is not satisfactory, and the procedure goes back to block 53.

At block 509, the comparison unit 49 switches the portable electronic device 100 into the unlocked state.

In use, a physical rotation of the portable electronic device 100 is used to input unlocking information without touches on the display screen 20. Therefore, a privacy of the portable electronic device 100 is improved.

While various embodiments have been described, the disclosure is not to be limited thereto. Various modifications and similar arrangements (as would be apparent to those skilled in the art) are also intended to fall within this disclosure. The scope of the appended claims should be accorded the broadest interpretation so as to encompass at least all such modifications and similar arrangements.

What is claimed is:

1. A portable electronic device capable of switching between a locked state and an unlocked state, the portable electronic device comprising:
a display screen;
a storage device configured to store unlocking information;
a control unit configured to control the display screen to display an unlocking interface when the portable electronic device is in the locked state, the unlocking interface comprising a compass with a plurality of prompting characters and a pointer;
an inputting unit configured to orderly input characters while the portable electronic device rotates to change the prompting character facing the pointer; and
a comparison unit configured to compare the input character and the unlocking information, and switch the portable electronic device into the unlocked state when the input information is identical to the unlocking information;
wherein one of the compass and the pointer rotates to change the prompting character facing the pointer.

2. The portable electronic device of claim 1, further comprising a sensing portion and an obtaining unit; wherein the unlocking information comprises a predetermined number of specified characters and rotating directions; the sensing portion senses a rotating direction of the portable electronic device while the portable electronic device rotates, the obtaining unit obtains the rotating direction of the portable electronic device via the sensing portion; the inputting unit stores the input character and the corresponding rotating direction as input information in the storage device.

3. The portable electronic device of claim 1, wherein the inputting unit counts a period of time of the portable electronic device stop rotating; when the counted time equals a predetermined time, the inputting unit obtains the prompting character facing the pointer as an input character.

4. The portable electronic device of claim 1, further comprising a counting unit and a determining unit; wherein the counting unit acquires a certain number of the input character, the determining unit determines whether the acquired number is equal to the predetermined value; when the acquired number is equal to the predetermined value, the determining unit determines that an input operation of the portable device is finished, and the comparison unit starts to compare.

5. The portable electronic device of claim 1, wherein the input characters are orderly displayed on the display screen.

6. The portable electronic device of claim 1, wherein the inputting unit controls the display screen to display a specified symbol on the unlocking interface when a character is input.

7. The portable electronic device of claim 1, wherein the compass rotates with the portable electronic device to change the prompting character facing the pointer; the pointer remains pointing to a predetermined direction while the portable electronic device rotates.

8. An unlocking method applied to a portable electronic device stored unlocking information and capable of switching between a locked state and an unlocked state; the unlocking method comprising:
displaying an unlocking interface with a compass and a pointer located in a middle of the compass on a display screen when the portable electronic device is in the locked state; the compass comprising a plurality of prompting characters, and one of the compass and the pointer rotating while the portable electronic device rotates;
obtaining a prompting character facing the pointer as input information;
comparing the input information with the unlocking information; and
switching the portable electronic device into the unlocked state when the input information is identical to the unlocking information.

9. The method of claim 8, wherein before the step of obtaining a prompting character facing the pointer as input information, the method further comprising:
obtaining a rotating direction while the portable electronic device rotates; and
storing the obtained rotating direction and the input character as input information.

10. The method of claim 8, wherein the step of obtaining a prompting character facing the pointer as input information further comprising:
counting a period of time of the portable electronic device being static;
determining whether the counted time equals a predetermined time; and
obtaining the prompting character faced the pointer as the input character when the counted time equals the predetermined time.

11. The method of claim 10, wherein the step of obtaining the prompting character facing the pointer as the input character when the counted time equals the predetermined time of further comprising:
displaying the input character on the unlocking interface orderly.

12. The method of claim 10, wherein the step of obtaining the prompting character facing the pointer as the input character when the counted time equals the predetermined time further comprising:
displaying a specified symbol while the input character is input.

13. The method of claim 8, wherein before the step of comparing the input information with the unlocking formation, the method further comprising:
acquiring a number of the input characters;
determining whether the number of the input characters is equal to a predetermined value; and
comparing the total input characters with the unlocking formation when the number of the input characters is equal to the predetermined value.

14. The method of claim 8, wherein the compass rotates and the pointer remains pointing to a predetermined direction while the portable electronic device rotates with the portable electronic device to change the prompting character facing to the pointer.
